(19) United States
(12) Patent Application Publication
(10) Pub. No.: US 2023/0272313 A1
(43) Pub. Date: Aug. 31, 2023

(54) COLOR CHANGING HAND WASH SOAP WITH TWO COLOR TRANSITIONS

(71) Applicant: Evelyn LYNCH, München (DE)

(72) Inventors: Evelyn LYNCH, München (DE); Fabian SCHÜLER, Hamburg (DE)

(21) Appl. No.: 18/016,238

(22) PCT Filed: Jul. 13, 2021
(86) PCT No.: PCT/EP2021/069538

§ 371 Date: Jan. 13, 2023

(30) Foreign Application Priority Data
Jul. 13, 2020 (DE) 10 2020 118 464.6
Jul. 24, 2020 (LU) LU101966

(51) Int. Cl. C11D 9/44; C11D 17/08; C11D 17/00; C11D 9/24

(52) U.S. Cl. CPC C11D 9/444; C11D 17/08; C11D 17/0013; C11D 9/24

(57) ABSTRACT

The present invention relates to a cleaning or soap product, in particular personal care product, in particular hand washing soap, comprising a first chemical and/or mechanical mechanism for generating a first color transition of the cleaning or soap product, and a second chemical and/or mechanical mechanism for generating a second color transition. Numerous embodiments and chemical-technical variants of the invention are disclosed.

### FIELD OF THE INVENTION

The present writing relates to an invention in the technical field of cleaning products, in particular hand washing products. In particular, the present invention creates a soap product. Further applications of the inventions are possible, for example in cleaning products, disinfectants or in medical needs.

### TECHNICAL BACKGROUND

Soaps with a single color transition are known from the prior art. For example, a soap is known in which a pH indicator in the soap can indicate a color change based on a change in a pH value.

Another soap is known in which a so-called thermochromic substance is used in the soap.

This thermochromic substance changes color when it reaches a certain temperature.

In addition, a soap is known that requires the user to mix two components that must be taken from separate containers.

However, the known prior art soap products have numerous disadvantages.

Often the transitions do not start at all and then very abruptly, which means a poor indicator effect for the user in relation to the use of the soap that has taken place.

One is often severely limited in the choice of colors, since thermochromics substances with transitions in the relevant temperature ranges are not known for many colors.

The processes are also usually reversible processes, which leads to strong disadvantages in terms of the indicator effect.

In an example using a thermochromics substance, the soap discolors due to a color transition based on the temperature of the hands or body of the user of the soap.

The processes are also usually reversible processes, which leads to strong disadvantages in terms of the indicator effect. In an example with a thermochromic substance, the soap discolors due to a color transition caused by the temperature of the hands or body of the user of the soap. However, with a subsequent wash-off, the soap unfortunately discolors back because it is a reversible thermochromic dye.

This is a counterintuitive effect for the user. since the color reversal when washing off suggests to the user that he has not used the soap sufficiently long or intensively after all.

By way of example, GB 2305 932 A discloses a bar soap that reversibly changes color when a transition temperature of the contained temperature-sensitive dye is exceeded within a temperature range of typically 30-35° C.

In this regard, WO 2006/137955 A1 discloses a cleaning composition comprising at least one surfactant and a plurality of thermochromic dyes configured to undergo a reversible color transition by a temperature change in the range between 21° C. to about 40° C. Such a composition can be used to provide a signal that helps improve cleaning effectiveness and/or safety and/or entertainment value.

Also known from WO 2007/070118 A1 is a cleaning composition that changes color during use. The cleaning composition contains a plurality of thermochromic dyes which cause a color change at a threshold temperature and continue a color change with a time delay over a temperature range. However, in this example, the color transition is also reversible, i.e., a color reversal occurs.

In another example with a pH indicator, the soap discolors due to the pH indicator, but then partially returns to its original color when it comes into contact with the pH-neutral water during washing. Here, too, a counterintuitive effect is created for the user, since the color change during washing suggests to the user that he has not used the soap for a sufficiently long time or intensively.

For example, DE 202010 005443 U1 discloses a cleaning agent comprising a first cleaning agent component for achieving a cleaning effect, and a second cleaning agent component distributed in the first cleaning agent component, the second cleaning agent component comprising at least one ingredient which leads to a color change of the cleaning agent, preferably upon a change in the pH value. However, the color change primarily serves to tell the user how much the cleaning agent discharged from the container (which is used in particular for cleaning toilets) has foamed up and whether it is still in its original relatively undiluted state or whether it has already been diluted or rinsed out.

Fine adjustment of parameters—such as controlled setting of the time and speed of a color transition—is not possible in the prior art. Frequently, one has to rely on the given chemical properties of a particular substance.

Even the color is often fixed. For example, however, the use of a soap, which after sufficiently intensive use turns to the color “red”, is not very intuitive and leads to numerous misunderstandings, especially among children, since “red” is rather a color with a warning effect and then does not encourage washing off.

In addition. U52005004915 A1 discloses a color change composition containing an indicator that triggers an observable reversible color change upon reaction with oxygen. The number of possible color change cycles ranges from 12 to 35 cycles. In addition, the indicator and the base material form a single phase. On the one hand, this setup allows fine adjustment of parameters—such as controlled setting of the timing and speed of a color transition. On the other hand, even in this case the color change and color return induce the aforementioned counterintuitive effect in the user, since the color return suggests to the user when washing up that he has not used the soap sufficiently long or intensively after all. The inventors therefore also assume that this disclosed reversible color change feature would provide a fun and playful aspect to a single-chamber liquid soap.

Storing two components for mixing and delivering them to the point of use is cumbersome and costly, and special soap dispensers and dosing devices are required to allow users to conveniently use soap with two- or multi-component soaps.

### DESCRIPTION OF THE INVENTION

The present invention has set itself the task of creating a soap which overcomes the disadvantages of the prior art, and of providing a color-changing soap which is flexible and easy to use, as well as inexpensive to manufacture, and which provides the user, especially children, with a resilient and readily perceptible indicator of sufficiently intensive use and of sufficiently long duration. In particular, more intuitively understandable colors (which are unfortunately often difficult to implement chemically) and the possibility of extensive fine-tuning are desirable in order to evoke an intuitive effect in users and especially in children (e.g. traffic light colors red-yellow-green, with whose meaning children are also intuitively familiar).

The task is solved by the cleaning or soap product according to claim 1. Numerous further embodiments result from the subclaims.

Accordingly, a cleaning or soap product, in particular a personal care product, in particular a hand washing soap, is provided which comprises a first chemical and/or mechanical mechanism for generating a first color transition within the soap continuum of the cleaning or soap product, and a second chemical and/or mechanical mechanism for generating a second color transition within the soap continuum of the cleaning or soap product.

A color transition in the sense of the invention can be a change from one color to another color, e.g. from red color to green color or vice versa. However, a color transition may also be a transition from colorless to a color or from a color to colorless. Black, white and transparent in particular are also to be considered as odors in the sense of the invention.

The two color transitions allow the soap to be configured in such a way that it is particularly convenient and especially intuitive for the user. For example, a first color transition occurs when the soap is removed or in the immediate vicinity of the start of a soaping process.

Then a second color transition occurs when the user has used the soap for a sufficiently long time and/or sufficiently intensively. For example, intuitive colors can also be selected in this way.

A chemical mechanism for producing a color transition of the cleaning or soap product comprises here the direct or indirect chemical reaction between a substance inducing this chemical reaction (e.g. acid, base, complexing agent, metal ions) and a dye, e.g. a color indicator and/or a color pigment and/or a substance, resulting in a color transition of the dye or the color indicator, which in turn results in a color transition within the soap continuum.

A mechanical mechanism for producing a color transition of the cleaning or soap product comprises in particular the breaking, mechanical shearing or destruction of a capsule-like structure which initiates and/or causes the release and/or mixing of a substance, e.g. a coloring substance, such as a dye, e.g. a color indicator or a color pigment into the soap continuum, so that the soap continuum undergoes a color transition.

Nevertheless, a mechanism for inducing a color transition of the cleaning or soap product may include a combination of a chemical mechanism and a mechanical mechanism. This is the case, for example, when the rupturing, mechanical shearing or disruption of a capsule-like structure, induces the release and/or mixing of a substance into the soap continuum, the released substance directly or indirectly inducing a chemical reaction between that substance (e.g. acid, base, complexing agent, metal ions) and a colorant, e.g. a color indicator and/or a color pigment and/or a substance. Another example is thermochromism, where thermochromic substances; pigments undergo a color transition as a result of a temperature change (physical quantity).

The first color transition here is, for example, a mechanical mechanism for generating a first color transition of the cleaning or soap product (i.e. mechanically induced color transition).

Here, a colorant and/or color pigments are present as a first substance enclosed, for example, within a capsule-like structure, in particular a gel capsule, wherein the first color transition is initiated and/or effected by a breaking, a mechanical shearing or a destruction of the capsule-like structure. As used herein, the term first mechanical mechanism for producing a first color transition of the cleaning or soap product refers to the release of the dye and/or color pigments enclosed within the capsules into the volume of the cleaning or soap product (soap continuum), causing the soap continuum to color in a color,

The subsequent second color transition takes place with a time delay and is here, for example, a chemical and/or mechanical mechanism for generating a second color transition of the cleaning or soap product (i.e. chemically and/or mechanically induced color transition).

Preferably, the time-delayed second color transition is a chemical mechanism for generating a second color transition of the cleaning or soap product, i.e. within the soap continuum.

According to a preferred embodiment, the chemical reaction comprises an involvement of at least one second substance, wherein the second substance is arranged, for example, in a first capsule-like structure, in particular gel capsule, or within the soap continuum.

Preferably, the second substance inducing the chemical mechanism for generating the second color transition of the cleaning or soap product is incorporated in a second capsule-like structure. As a result, the first and second substances are initially separated from each other by the capsule-like structure. Only after the capsule-like structure has been broken open can a chemical reaction take place which causes a color change. This has the advantage that the second substance can be released with a time delay, which allows a gradual and/or controlled transition and fine tuning, in particular also of a color change timing within the second mechanism. In this way, desired properties and parameters can be influenced and adjusted.

The second substance is, for example, an add and/or base which causes a change in pH value, a complexing and/or water hardness-altering substance (i.e. a complexing agent) which causes a color transition by complexation. The chemical reaction induced in this way changes the color of the dye and/or color pigment released into the cleaning or soap product by the first-mechanically induced-color transfer.

According to a nevertheless preferred embodiment of the present invention, the time-delayed second color transition is a mechanical mechanism for generating a second color transition of the cleaning or soap product, i.e. within the soap continuum. In this regard, the mechanism for generating the second color transition of the cleaning or soap product comprises the participation of at least one second substance. The second substance inducing the mechanical mechanism for generating the second color transition of the cleaning or soap product is preferably arranged in a second capsule-like structure, in particular gel capsule. As a result, the first and second substances are initially separated from each other by the capsule-like structure. Only when the capsule-like structure is broken open is the second substance released into the soap continuum, which causes a second color change. Preferably, the second substance is a second dye and/or a second color pigment.

By using two mechanisms for the two color transitions, the parameters of the soap and the color transition behavior can be fine-tuned particularly well. Desired colors can be achieved.

Transitions can be made at the desired speed or delay can be set so that these take place neither too quickly nor too slowly. For example, a time period until a second color change, or an intensity requirement for a use, can be implemented efficiently and reliably in this way. The mechanisms can be selected largely independently of each other. For example, pigments but also other substances causing a color change can be released from capsules or other carrier structures. This means that even complex chemical active ingredient systems have access to use in the soap, since, for example, a substance is released and can react successively to produce a color change with another substance already present in the soap continuum. Merely by way of example, an active substance system consisting of glucose and methylene blue may be mentioned.

Reactions with environmental substances, such as atmospheric oxygen, may also be involved in the color change mechanisms of the soap.

It is understood that the cleansing or soap product defined herein is brought into contact with the skin of a human being for a sufficiently long time and intensively when used as intended.

Thus, the term soap continuum is used synonymously for the cleansing or soap product before as well as during the intended use (e.g., during application to the skin and/or in contact with water) of the cleansing or soap product.

According to a further embodiment, the second chemical and/or mechanical mechanism is effected with a time delay with respect to the first chemical and/or mechanical mechanism.

For example, a first color transition occurs when the soap is removed or in the immediate vicinity of the start of a soaping process (e.g. also through an oxygen-induced reaction with a first dye). Then a second color transition occurs when the user has used the soap for a sufficiently long time and/or sufficiently intensively.

This is particularly meaningful and intuitively understandable for the user.

According to a further development, a capsule-like structure, in particular gel capsule, is used in the first and/or second chemical and/or mechanical mechanism, wherein the first color transition is initiated and/or effected by a rupture, mechanical shearing or destruction of the capsule-like structure.

An important advantage is that a gradual color transition is made possible by successively breaking open further capsules when using the soap. In addition, the color transition indicates a sufficiently intensive or sufficiently thorough use of the soap product. This has advantages in particular also over indicators which merely induce an elapsed time. This soap can encourage users, especially children, to use the soap sufficiently thoroughly. Simply waiting, on the other hand, does not lead to a color change.

A capsule-like structure comprises, for example, a shell and a content. However, a capsule-like structure in the sense of the invention can also be a carrier structure which is based, for example, on homogeneous or inhomogeneous mixing. In one example, this is a globule, in particular a fat globule or a wax globule, the substance of the globule being mixed with a dye or a substance involved in a color transition. A globule is by no means necessarily spherical, but can have various shapes.

Merely one example of a material of a capsule-like structure is a nanocomposite polymer network, wherein the nanocomposite polymer network is a physically crosslinked nanocomposite polymer. Examples herein include, in particular, calcium alginate and nanocomposite polymer networks comprising a physically crosslinked nanocomposite polymer of at least one organic polymer and at least one type of clay mineral particle.

Alginate capsules are used in a variety of applications and are therefore readily available.

A solid capsule can also be used, for example. These are readily available and inexpensive to manufacture. For example, it can be a polymer capsule.

To achieve a stable coating of the capsule-like structure, it is preferred that a crosslinked polysaccharide was used as a coating layer by crosslinking a polysaccharide with a crosslinking agent with or without the use of a polyol spacer.

In principle, the present invention is not limited with respect to the chemical nature of the polysaccharide of the at least one coating layer of the capsule-like structure. In particular, good results are obtained when the polysaccharide of the at least one coating layer is selected from the group comprising starch, cellulose, chitin, carrageenan, agar and alginates. It is particularly preferred that the polysaccharide of the at least one coating layer is a carrageenan or an alginate, and it is particularly preferred that the polysaccharide of the at least one coating layer of the capsule-like structure is an alginate. In the context of the present invention, it has been found that these polysaccharides ensure good storage stability of a dye enclosed therein and, at the same time, during the intended use of the cleaning product, rupture or destruction of the capsule-like structure can be initiated and/or effected, with the parameters of the capsule-like structure being particularly well adjustable.

It is essential to the invention that the polysaccharide of the at least one coating layer of the capsule-like structure is crosslinked, In this regard, the crosslinking of the polysaccharide according to one embodiment of the present invention can take place via covalent bonds.

Crosslinking via covalent bonds enables very durable coatings. In this case, crosslinking via covalent bonds is usually carried out by reacting the polysaccharide with a suitable crosslinking agent. In particular, difunctional organic compounds are suitable as crosslinkers, the functional groups being selected, for example, from the group consisting of carboxylic acids, salts of carboxylic acids, activated carboxylic acids, amines, alcohols, aldehydes and ketones, In this context, activated carboxylic acids are understood to mean carboxylic acid halides, active esters of carboxylic acids, anhydrides of carboxylic acids or other reactive derivatives of carboxylic acids.

According to an alternative and particularly preferred embodiment of the present invention, the polysaccharide of the at least one coating layer of the capsule-like structure is crosslinked via ionic and/or coordinative bonds. Such polysaccharides crosslinked via ionic and/or coordinative bonds are particularly easy to prepare and do not impair the biodegradability of the polysaccharide used. The ionic and/or coordinative crosslinking can be achieved, for example, by polysaccharides which have anionic groups, such as carboxylate groups or sulfonate groups. By introducing divalent or higher-valent cations, in particular alkaline earth metal ions (such as calcium and/or magnesium ions), ionic and/or coordinative crosslinking of the anionic groups of the polysaccharide then takes place to form a stable coating layer.

According to one aspect of the present invention, capsule-like structures can be used in cleaning and soap products which, for example, exhibit (strongly) hydrophobic properties due to the material or structure/crosslinking. For example, these capsules have hydrophobic properties that are too pronounced for functional use in the context of aqueous solutions. For example, however, these capsules have other, very advantageous properties. Only exemplary are stability, fine adjustment of properties, simple manufacturing process as well as the possibility of small structure sizes. The experiments in the context of the creation of the present invention have shown that in the context of an application with soaps/surfactants, materials for capsule-like structures or other carrier structures with (strongly) hydrophobic properties are also suitable. Soaps and surfactants can provide good solubility or uniform distribution of such capsules even, for example, in an essentially aqueous solution. This effect is made possible, for example, by the polar as well as the non-polar part of a surfactant (effective reduction of an interfacial tension).

This insight makes particularly stable, particularly well finely adjustable and particularly simple and inexpensive capsule-like structures accessible for use within the scope of the present invention. Only one example is formed by strongly hydrophobic polymer capsules, in particular polymer capsules with small structure size.

Thus, a capsule can be produced which, for example, has a structure size and material such that uniform distribution of the capsules is no longer maintained in water (for example, clumping or the like occurs), but whose use in the context of a surfactant/soap chemical structure is possible without complications and to advantage.

For example, hydrogels can be used which would otherwise have too many hydrophobic components in relation to their hydrophilic components. Such hydrogels often have important advantages, for example in terms of stability and diffusion behavior.

For example, surfactants improve solubility or homogeneous distribution of the capsule-like structures in the long term.

Preferably, the capsule-like structure is impermeable to water and low in diffusion.

According to a further embodiment, the capsule-like structure may comprise a starch including starch derivatives, a modified cellulose, a natural gum, a wax, a fatty acid, a fatty alcohol, a multifunctional alcohol, colloidal or pyrogenic particles, a fatty acid ester, a polyoxyethylene glycol ether, or mixtures thereof.

The capsule-like structures allow a combination with numerous active ingredient systems and pigments to create the color transitions. According to a further embodiment, the second chemical and/or mechanical mechanism employs a capsule-like structure that differs from the capsule-like structure employed in the first chemical and/or mechanical mechanism, particularly when it differs in at least one aspect from: Size, thickness, material, surface finish.

This allows effective fine tuning of the desired parameters of the soap and color transition. In particular, a desired time delay or use intensity requirement between color transitions can also be efficiently adjusted.

According to a further development, the first and/or the second chemical and/or mechanical mechanism is based on a chemical reaction. This makes enormously versatile chemical reactions accessible to an application in the soap sector.

According to a further embodiment, the chemical reaction comprises an involvement of at least a first and a second component, wherein the first component is arranged in a first capsule-like structure, in particular gel capsule.

As a result, the components are initially separated by the capsule-like structure. Only when the capsule-like structure is broken open can a chemical reaction take place that causes a color change.

According to a further embodiment, the second component is arranged in the soap continuum.

As a result, the components are initially separated by the capsule-like structure. Only when the capsule-like structure is broken open can a chemical reaction take place that causes a color change. The mixing required for this takes place particularly efficiently when the second component is free in the soap continuum.

According to a further development, the second component is arranged in a second capsule-like structure, in particular gel capsule.

This means that the components are initially separated by the capsule-like structures. Only when the capsule-like structures are broken open can the chemical reaction take place that causes a color change. This opens up numerous new reaction possibilities. For example, a color change can also be produced when the first capsule-like structure breaks open, on the basis of a dye which is decolorized again by another substance, which is brought about when the second capsule-like structure breaks open later. This is just one example of one of the many new reaction topologies.

According to further development, the cleaning or soap products according to the invention contain the encapsulated dyes in amounts sufficient to achieve the desired coloring effect, i.e. in amounts from 0.1 to 80% by weight, more preferably from 1 to 20% by weight and most preferably from 2 to 10% by weight.

Typical concentrations for the colorant are in the range between 0.01-1% by weight based on the mass of all components of the soap. The concentration of the indicator can be selected or specifically adjusted by the skilled person depending on the desired color intensity.

According to a further development, the cleaning or soap product according to the invention comprises at least one “indicator” as a colorant, the indicator being selected from the group comprising pH indicators, redox indicators, complex indicators (metal indicators) and thermal indicators (for indicating a temperature range).

According to a further development, the second chemical and/or mechanical mechanism relies on a chemical reaction caused by contact with oxygen, in particular atmospheric oxygen.

In this way, the ambient air can be used as a reaction partner. This is particularly simple and also provides a good indicator for an intensity of a washing process.

According to a further embodiment, the first and/or second chemical and/or mechanical mechanism relies on a reaction caused by exposure to light.

This is particularly efficient. For example, such a photosensitive soap is contained in an opaque container. However, after removal and during washing, the soap is then exposed to light. According to a further development, the first and/or second chemical and/or mechanical mechanism is based on a reaction involving a hydrolipid film.

During washing, the soap is exposed to the skin and in particular to its protective acid mantle. This is used to advantage by involving the hydrolipid film in the production of a color change.

According to a further development, a thermochromic substance (known to the skilled person as a thermoindicator) is used in the first and/or second chemical and/or mechanical mechanism.

Thus, heating during use, for example hand heat during hand washing, can be used to produce at least one desired color transition.

According to a further development, a pH-value-indicating substance is used in the first and/or second chemical and/or mechanical mechanism, in particular a pH-value-indicating substance (known to those skilled in the art as a pH indicator) which is suitable for indicating an envelope in the range from pH 4.5 to pH 9, in particular at least one of: Methyl red, alizarin red, chlorophenol red, p-nitrophenol, hematoxylin, litmus, azolitmin, bromothymol blue, phenol red, neutral red, cresol red, naphtholphthalein, in particular mixtures of at least two pH-indicating substances. pH indicators are available in numerous different color variants, Therefore, this has the advantage that desired color transitions can be achieved more easily, including by combining several indicators. Commercial products are readily available.

The following are some examples, which should not be regarded as conclusive: Methyl red (pH envelope at 4.4-6.2; red-yellow) ; Alizarin red (pH envelope at 4.5-6.0; yellow-red); Chlorphenol red (pH envelope at 4.8-6.4; yellow-violet); p-Nitrophenol (pH envelope at 5.0-7.0; colorless-orange-yellow); Hematoxylin (pH envelope at 5.0-7.2; yellow-purple); Litmus (pH envelope at 5.0-8.0; red-blue); Azolitmin (pH envelope at 5.0-8.0; red-blue); Bromothymol blue (pH envelope at 5.8-7.6 a yellow-blue); Phenol red (pH envelope at 6.4-8.0; yellow-red-violet); Neutral red (pH envelope at 6.8-8.0; red yellow); Cresol red (pH envelope at 7.2-8.8 ; yellow-violet) Naphtholphthalein (pH envelope at 7.3-8.7; colorless/reddish-blue-green)

According to a further development, a carrier structure, in particular in the form of beads and/or powder, in particular beads and/or powder comprising waxes, fats or oils, is used in the first and/or second chemical and/or mechanical mechanism, the second color transition being initiated and/or brought about by melting the carrier structure.

This has the advantage that an “alternative thermochromic effect” is generated. This makes pigments that do not have to be thermochromic available for use in the context of a temperature- and washing-intensity-dependent color change.

For example, the carrier structure is small beads and/or powder of waxes, fats or oils mixed with a dye. In another example, the carrier structure is small beads and/or powders of waxes, fats or oils mixed with a reagent that reacts with another substance to produce a color change. Other powders are also conceivable.

Powders are easy to produce in large quantities and are easy to incorporate into the soap. In particular; homogeneous distributions can be well realized by powders.

According to a further development, a pH-altering substance is used in the first and/or second chemical and/or mechanical mechanism, in particular a pH-altering substance which is incorporated in a capsule-like structure or other carrier structure, in particular beads and/or powder comprising waxes, fats or oils, in particular an acid and/or base, in particular citric acid and/or soda.

As used herein, “capsule-like structure” means preferably spherical aggregates having a diameter of about 0.01 to about 5 mm and containing at least one solid or liquid core surrounded by at least one continuous membrane. More specifically, these are finely dispersed liquid or solid phases coated with preferably film-forming polymers, in the preparation of which the polymers are applied to the material to be encapsulated after emulsification and coacervation or interfacial polymerization. In another process, liquid dyes are absorbed into a carrier structure (“microsponge”) and additionally coated with film-forming polymers as microparticles. The capsule-like structures, also called nanocapsules, can be dried like powder.

The membrane can be made of natural, semi-synthetic or synthetic materials. Natural membrane materials include gum arabic, agar agar; agarose, maltodextrins, alginic acid and its salts, e.g., sodium or calcium alginate, fats and fatty adds, cetyl alcohol, collagen, chitosan, lecithins, gelatin, albumin, shellac, polysaccharides, such as starch or dextran, polypeptides, protein hydrolysates, sucrose, and waxes. Semi-synthetic membrane materials include chemically modified celluloses, in particular cellulose esters and ethers, e.g. cellulose acetate, ethyl cellulose, hydroxypropyl cellulose, hydroxypropyl methyl cellulose and carboxymethyl cellulose, and starch derivatives, in particular starch ethers and esters. Synthetic membrane materials are, for example, polymers such as polyacrylates, polyamides, polyvinyl alcohol or polyvinylpyrrolidone.

In addition to mononuclear capsule-like structures, multinuclear aggregates, also called microspheres, containing two or more nuclei distributed in the continuous medium of the soap can also be considered. This has the advantage of facilitating a time-delayed release of the dyes. Thus, in a first step, the first substance is first released from the first core, which induces the first chemical and/or mechanical mechanism for generating a first color transition within the soap continuum of the cleaning or soap product, the first color transition being initiated and/or caused by a rupture, mechanical shearing or disruption of the capsule-like structure of the first type. This is followed by the release of the second substance in a second step, wherein the second substance induces the second chemical and/or mechanical mechanism for generating a second color transition within the soap continuum of the cleaning or soap product, wherein the second color transition is initiated and/or effected by a break-up, a mechanical shearing or a destruction of the capsule-like structure of the second kind.

By actively influencing the pH value, the color of pH indicators can be actively influenced within the soap. For example, by introducing them into the capsule-like structure or other carrier structure, release and discoloration by means of the pH indicator takes place only successively and in a manner dependent on time and/or washing intensity. In this way, in particular; fine adjustments of parameters of the soap and its color transitions can be efficiently realized. According to a further development, a complex-forming and/or water hardness-degree-changing substance (known to the skilled person as a complex indicator) is used in the first and/or second chemical and/or mechanical mechanism, which substance is introduced into a capsule-like structure (102) or other carrier structure (103), in particular beads and/or powder comprising waxes, fats or oils, in particular complex-forming agents, in particular hardness-forming agents in the sense of water hardness, in particular ions of alkaline earth metals, in particular calcium, magnesium, strontium and/or barium ions, and/or iron and/or aluminum ions.

In this case, as at least one substance, a dye or a color pigment is provided, which is a complex indicator (metal indicator).

By actively influencing the degree of hardness, the color of hardness indicators, such as eriochrome black-T, can be actively influenced within the soap. By introducing the water hardness-degree-changing substance into the capsule-like structure or other carrier structure, for example, release and discoloration by means of the hardness-degree indicator occurs only successively and as a function of time and/or washing intensity. In this way, fine adjustments of parameters of the soap and its color transitions in particular can be efficiently realized.

For example, calcium, magnesium, strontium and/or barium ions are released. This can increase water hardness, for example.

A complexing agent can also be used, for example, to lower a water hardness. For example, a plasticizer is used. For example, this is EDTA. In one example, EDTA is a stronger complexing agent than eriochrome black-T.

As a result, for example, color transitions of a complexing agent, for example eriochrome black T, can be used in all color change directions. For example, blue or orange to purple, but also purple to blue or orange can be used as a color change. These color transitions can also be varied and combined using a mixing indicator.

According to a further development, the first chemical and/or mechanical mechanism produces a color transition which is substantially effected and visible at a time of a withdrawal and/or a start of a use of the cleaning or soap product. This clearly suggests to the user that the user can start using the soap. In addition, it is clearly suggested to the user that he or she should not yet start washing off the soap because sufficient use of the soap has not yet occurred. In one example, this is the color red. In another example, this is the color “colorless”.

According to a further embodiment, the second chemical and/or mechanical mechanism produces a color transition which is substantially effected and visible at a point in time after a certain time and/or a certain accumulated intensity of use of the cleaning or soap product.

This clearly suggests to the user that he can or should start washing off the soap, since sufficient use of the soap has taken place. In one example, this is the color green, in another example, this is the color “colorless”.

According to a further development, a red thermochromic dye is used, in particular in a capsule-like structure or another carrier structure, and a green interval pigment is used, in particular in a capsule-like structure or another carrier structure.

Red thermochromic pigments, which become colorless above a certain temperature, and green interval pigments, are particularly efficiently available and easy to use. In particular, commercial products are readily available on the market for this purpose, making the manufacture of the cleaning or soap product simpler and thus more cost-effective. Hereby, an effective red-green transition or red-colorless-green transition can be realized efficiently with simple and readily available means.

According to a further development, a substance comprising methylene blue and/or indigo carmine is brought into use, in particular in a capsule-like structure or another carrier structure, as well as a substance comprising glucose, in particular in a capsule-like structure or another carrier structure.

Methylene blue exhibits a dyed state of blue color. Methylene blue can be decolorized by glucose, for example. It can be dyed by oxygen. In particular, methylene blue can thus be successively, i.e., in particular reversibly, dyed blue and decolorized again.

For example, methylene blue is present in blue, i.e. colored, form. Methylene blue can be reduced to the colorless leuco form, called leuco-methylene blue. For example, this is done by glucose, which is oxidized to gluconic acid in the process. In this process, leuco-methylene blue can be oxidized to the methylene blue with blue color by a suitable oxidizing agent. A suitable oxidizing agent can be oxygen, in particular atmospheric oxygen. This has the effect that a color transition in a soap, which occurs when the soap is used, can be effectively and inexpensively realized by the high surface contact of the soap with atmospheric oxygen during the soaping process. In particular, no separate substance, mechanism or oxidizing agent is required for this purpose.

Indigo carmine is versatile, as it can act as a pH as well as a redox indicator. Due to the possible yellow discoloration, it is also particularly well suited for producing a green color by subtractive color mixing, for example when combined with a blue dye, such as methylene blue. A green color is particularly desirable for an intuitively understandable handwashing soap as a signal indicator for “please wash up”.

According to a further development, a substance or mixture of substances is used, comprising at least one leuco dye, in particular one of: Methylene Blue, Indigo, Indigo Carmine, Safranin T, Tillmans Reagent, in particular in a capsule-like structure or another carrier structure.

Such leuco dyes are particularly well suited and readily available as part of commercial products.

The term “leuco dye” is to be understood broadly and is in particular not limited to a leuco form of such a substance. For example, the term includes both methylene blue and leuco-methylene blue. Only a suitability as use in the context of a leuco dye is presupposed.

According to a further development, a substance comprising a hardness indicator, in particular eriochrome black-T, and/or complexing agents, in particular murexide, ethylenediaminetetraacetate or acetic acid (EDTA), dimethylglyoxime, alizarin, diphenylcarbazide, yellow and/or red blood liquor salt, in particular in a capsule-like structure or another carrier structure, and a substance comprising complexing agents and/or hardness formers, in particular calcium and/or magnesium ions, in particular in a capsule-like structure or another carrier structure.

This system is another valuable chemical active ingredient system for generating a color change and opens up the use of many other substances in the context of soap products.

Thus, a color change can be generated based on a hardness indicator or complexing agent.

According to a further development, a substance comprising a redox dye and/or leuco dye, in particular Tillman's reagent, is brought into use, in particular in a capsule-like structure or another carrier structure, as well as a suitable oxidizing and/or reducing agent, in particular ascorbic add.

This system is another valuable chemical agent system for producing a color change and opens up the use of many other substances in the context of soap products.

Thus, a color change based on a redox dye and/or leuco dye es can be generated.

By using a suitable oxidizing and/or reducing agent, for example in the context of a second capsule-like structure or other carrier structure, the color change can be actively controlled depending on the intensity of use,

For example, by using ascorbic acid, for example as part of a second capsule-like structure or other support structure, an exemplary color change based on Tillman reagent can be actively controlled based on intensity of use.

According to a further development, a substance comprising a phthalocyanine compound, in particular copper phthalocyanine compound, in particular polychlorinated copper phthalocyanine or a polychlorinated copper phthalocyanine compound, in particular phthalocyanine green, is used.

These compounds have desirable properties, very noticeable colors, and are readily and inexpensively available because they are produced on a large industrial scale. In particular, commercial products are readily available on the market for this purpose, making the production of the cleaning or soap product simpler and thus less expensive.

According to a further embodiment, there is used a substance comprising a compound comprising at least one of: Phthalo green, Phthaloblue, Carmine, Sudan IV, Quinacridone, Dioxazine violet, Isoindolinone yellow; Isoindolinone orange, Isoindolinone yellow orange, Anniline black, Alizarin, Alizarin yellow R.

These compounds have desirable properties, a wide variety of colors, and are readily and inexpensively available in large quantities. In particular, commercial products are readily available on the market for this purpose, making the manufacture of the cleaning or soap product simpler and thus less expensive.

According to a further development, the second chemical and/or mechanical mechanism operates on the basis of a limited and/or delayed onset solubility, in particular water solubility, of a substance, in particular a free substance and/or substance provided in a capsule-like structure or other carrier structure.

This mechanism is particularly simple, and experiments have shown that it works surprisingly well. The solubility allows a gradual, controlled transition and allows for fine tuning, especially of a color change timing in the context of a second mechanism. Thus, desired properties and parameters can be influenced and adjusted.

The use of a free substance is particularly simple. For example, calcium carbonate is added to the soap. For example, however, this does not go directly, in particular not completely into solution. For example, more of it is thus successively dissolved during a washing process, and thus, for example, the water hardness can be influenced. For example, a color change is triggered by this. For example, one can thus do without a capsule-like structure and/or carrier structure, but one does not necessarily have to do so.

According to a further development, the substance comprises a hardener, complexing agent and/or plasticizer.

For example, the water hardness is influenced by this. For example, the water hardness can increase, but also decrease. Through this, a color change can be provided efficiently.

According to a further development, the substance comprises a calcium, magnesium, strontium, barium, iron and/or aluminum compound or ion, in particular calcium or magnesium compound, in particular carbonate compound, in particular calcium carbonate.

For example, when the substance or parts thereof are successively dissolved during the washing process, a color change is caused and provided, for example by a hardness indicator or also by means of complexing agents.

Calcium, magnesium, strontium, barium, iron and/or aluminum compounds or ions, in particular calcium or magnesium compounds, especially carbonate compounds, in particular calcium carbonates, are particularly suitable for this purpose.

According to a further development, at least one chemical and/or mechanical mechanism for generating a color transition of the cleaning or soap product is irreversible or virtually irreversible. The term irreversible means herein that the original color state (i.e. the color state that existed prior to this chemically and/or mechanically induced color transition) cannot be achieved again or can only be achieved again by adding another substance. The irreversible color transition is one that cannot return to the original color state due to a chemical reaction and/or thermodynamic or kinetic inhibition. Thus, thermochromism or a thermosensitive reaction is not a typical example of an irreversible color transition. So-called “oscillating” reactions are also not a typical example of an irreversible color transition. The process of the chemical and/or mechanical mechanism for producing a color transition of the cleaning or soap product as irreversible or almost irreversible has the essential advantage that a counterintuitive effect for the user is absent, which would suggest to the user as a result of a color reversal when washing off that he has not used the soap sufficiently long or intensively after all.

A typical example of an irreversible color transfer—as understood herein—is the release of a dye and/or color pigment into the soap continuum. The skilled person knows that high amounts of energy must be applied to separate the dye and/or color pigment.

Another example of an irreversible color transition—as understood herein—is the release of an acid or base as a first or second substance into the soap continuum, which in a direct or indirect chemical reaction with a dye, e.g. a pH indicator, leads to a change in the color of the dye. The skilled person knows that he can induce the color reversal only by changing the pH value. This means that another substance, i.e. a corresponding base or acid, must be added to the soap continuum in order to shift the pH value accordingly.

As a further example of an irreversible color transition—as understood herein—serves the release of a complex indicator (coloring complexing agent) as a first or second substance into the soap continuum, wherein, for example, a chemical and/or mechanical mechanism for producing a first color transition of the cleaning or soap product is achieved by the fact that the added or released complex indicator is released by complexing metal ions, in particular calcium ions or magnesium ions (which, for example, are present in the soap product or are added to the soap product via water during the intended use of the soap product), is achieved, for example, by the added or released complex indicator carrying out a—chemically induced—color change by complexing metal ions, in particular calcium ions or magnesium ions (which are present, for example, in the soap product or are supplied to the soap product via water during the intended use of the soap product). In this case, a further substance, i.e. a complexing agent with a stronger tendency to complexation, such as ethylenediaminetetraacetate (EDTA) or sodium gluconate, must be added to or released into the soap continuum to indicate a color change.

According to a further embodiment, an irreversible or nearly irreversible color transition is a mechanically induced color transition induced by the rupture or mechanical shearing or melting of a capsule like structure or other support structure, inducing the release of a substance, in particular an indicator and/or color pigment into the soap continuum and the dispersion and/or mixing of this substance into the soap continuum.

According to a further embodiment, the first and second chemical and/or mechanical mechanisms for producing a color transition of the cleaning or soap product are irreversible or nearly irreversible.

### DESCRIPTION OF EXEMPLARY EMBODIMENTS

According to one embodiment, a thermochromic substance is used. For example, this dye is red. For example, this dye is red and changes by color transition to a color “colorless” when a certain temperature is exceeded. For example, this temperature is below the usual skin temperature of a human. For example, this is a temperature below 32, 30, 28 or 25 degrees Celsius. This allows the pigment to decolorize (or dye or change color) if it is brought into contact with a person's skin for a sufficiently long time and intensively.

In one example, another thermochromic substance is used. For example, this is a green pigment. Such a thermochromic pigment may, for example, exhibit a color transition from green to colorless (and/or vice versa). In particular, this may be a green so-called interval pigment. For example, the interval pigment is green at a temperature between 30 and 50 degrees Celsius, but otherwise has the color “colorless”.

In one example, an effective color transition from red to green, or from red to colorless to green, can be produced by combining the two substances.

The substances can be located in the soap continuum. However, they can also be in a capsule-like structure or another carrier structure, so that they are only released when, for example, mechanical forces act on the soap. This statement may refer to the first substance, the second substance, or both substances. For example, the first substance may also be incorporated in a capsule-like structure or another carrier structure of the first type, while the second substance may be incorporated in a capsule-like structure or another carrier structure of the second type. In particular, the capsules may be of different types and may be of different robustness.

Capsule-type structures can have various sizes. For example, but by no means exhaustively, a single capsule or support structure has a size in the centimeter range, the millimeter range, or the micrometer range.

Capsule-like structures and other carrier structures can also include so-called hydrogels. These are very low in diffusion. As a result, the cleaning and soap product has a very long shelf life.

Examples of chemically crosslinked polymers are so-called hydrogels, which consist of monomer units, such as e.g. tertiary butylaminoethyl methacrylate (TBAEMA) n-butylaminoethyl methacrylate (NBAEMA), diethylaminoethyl methacrylate (DEAEMA), dimethylaminoethyl methacrylate (DMAEMA), diisopropyaminoethyl methacrylate (DPAEMA), dibutylaminoethyl methacrylate (DBAEMA), dipropylaminoethyl methacrylate (DPAEMA), ternary pentylaminoethyl methacrylate (TPAEMA), tertiary hexylaminoethyl methacrylate (THAEMA), tertiary butylaminopropyl methacrylate (TBAPMA), diethylaminopropyl methacrylate (DEAPMA), and dimethylaminopropyl methacrylate (DMAPMA), or a combination thereof.

In another example, methylene blue can be used as a dye. Methylene blue exhibits a dyed state of blue color. Methylene blue can be decolorized by glucose, for example. It can be dyed by oxygen. In particular, methylene blue can thus be successively, i.e., in particular reversibly, dyed blue and deodorized again.

For example, methylene blue is present in blue, i.e. colored, form. Methylene blue can be reduced to the colorless leuco form, called leuco-methylene blue. For example, this is done by glucose, which is oxidized to gluconic add in the process. In this process, leuco-methylene blue can be oxidized to the methylene blue with blue color by a suitable oxidizing agent. A suitable oxidizing agent can be oxygen, in particular atmospheric oxygen. This has the effect that a color transition in a soap, which occurs when the soap is used, can be effectively and inexpensively realized by the high surface contact of the soap with atmospheric oxygen during the soaping process. In particular, no separate substance, mechanism or oxidizing agent is required for this purpose.

In another example, a green dye is used, which is released when the soap is used. For example, such a green dye is present in capsule-like structures in the soap. In another example, such a green dye is present in another carrier structure. For example, such other carrier structure may be provided by small beads of waxes, fats or oils which are mixed with a reagent or dye. In one example; a green dye is mixed with cocoa butter and is provided in the form of small beads.

Such other carrier structures also have numerous advantages. For example, an “alternative thermochromic effect” can be produced. For example, small globules of waxes, fats or oils are designed to be mechanically destroyed and/or to melt by thermal action (e.g. heat of the hands) when the soap is used. As a result, the colorant is only released when the soap is used, in particular when the soap is used for a sufficiently long period and/or with sufficient intensity, and thus colors the soap continuum or the soap foam.

Another aspect of the invention deals with one or more further added colorants. In particular, a further colorant may be added to achieve a desired target color via a subtractive color mixing mechanism.

In one example, a color transition is realized by methylene blue. However, the desired target color is green, not blue, for example because “green” as a traffic light color promises an intuitive technical meaning for the user of the soap.

For example, a yellow dye can be added. In one example, such a yellow dye is quinoline yellow. For example, in the context of subtractive mixing of blue and yellow, a green color results when the methylene blue is in the blue-colored form (not as leuco-methylene blue). In one example, this results in a color transition from yellow to green instead of a color transition from colorless to blue (or in the opposite direction in each case).

In another example of the invention, a substance released from a capsule-like structure or other support structure reacts with a substance already present in the soap continuum or released from another capsule-like structure/support structure (e.g., second type).

The color transition can be caused by different mechanisms or combinations of different mechanisms, for example redox reactions, pH changes with pH indicator, stereochemical structural changes, thermochromism, thermosensitive reactions, etc.

In one example, Tillman's reagent is used. This is red in the acidic environment.

In one example, Tillman's reagent is incorporated into a capsule-like structure or other carrier structure. The soap continuum contains vitamin C or ascorbic acid.

In one example, Tillman's reagent is in the soap continuum. Vitamin C or ascorbic acid is incorporated into a capsule-like structure or other second type carrier structure. In one example, Tillman's reagent is incorporated into a capsule-like structure or other carrier structure. Vitamin C or ascorbic acid is incorporated into a capsule-like structure or other second type carrier structure.

During soaping, the capsule-like structure or the other carrier structure is destroyed and the contents are successively released. For example, the acidic environment and the pH indicator can cause a color transition of the soap during soaping.

The rupture or mechanical shearing or melting of the capsule-like structure or the other carrier structure may represent a first mechanism, whereas a release of the contents of the capsule-like structure or the other carrier structure of a second type may be understood as a second mechanism. Discoloration of the pH indicator may also represent a second mechanism.

For example, either the pH indicator or the chemical basis of the acidic environment conies from a capsule-like structure or the other support structure.

The structural variants according to the invention (comprising, for example, substance 1 in capsules/carrier, substance 2 in the soap continuum; substance 2 in capsules/carrier, substance in the soap continuum; substance 1 in capsules/carrier of the first type, substance 2 in capsules/carrier of the second type, and many more.) can also be combined with other substances according to the invention. In each case, numerous other substances can also be added, i.e. the capsules/carriers can comprise one or more substances essential for a color transition, but also other substances.

For example, eriochrome black T can be used, which can act as a pH indicator, but which can also react with compounds or solutions comprising, for example, ions of alkaline earth metals. Calcium and magnesium ions are only given as examples.

Through this system, for example, a color change between a purple hue and a red hue, a red hue and a blue hue, a blue hue and an orange hue, a red hue and an orange hue, or a red hue and a green hue can be achieved.

It can also be used as a mixed indicator, For example, eriochrome black T can be combined with methyl orange. For example, a gray shade or intermediate shade is also possible. All named and unnamed pH indicators can also be combined by all named and unnamed substances that influence the pH environment. For example, a combination of one or more pH indicators with citric acid is conceivable. A combination of one or more pH indicators with soda is also conceivable.

Synergistic effects are achieved by combining with the capsule-like structures or the other carrier structures. For example, precise fine-tuning (fine-tuning) of a time or intensity point of a first color transition, a time or intensity point of a second color transition and the desired color shades is possible by the invention.

A system based on indigo carmine is also conceivable. For example, a system consisting of indigo carmine and glucose is conceivable. This makes a color change from blue to yellow conceivable, for example. By combination with other systems, the generation of other color transitions by subtractive color mixing is possible.

According to a further development, the cleaning or soap products according to the present invention represent liquid soaps and hand washing pastes, preferably aqueous liquid soaps and hand washing pastes having a Brookfield viscosity (RVT, spindle 3, 10 rpm) of 300 to 30000, more preferably 1,000 to 5,000 and most preferably 2,000 to 3000 mPas.

According to a further development, the cleaning or soap product, in particular personal care product, in particular hand washing soap, is a substantially liquid cleaning or soap product.

In order to set the desired color effect (i.e. time-delayed or sequential sequence of color transition), various methods can basically be used in which a dye reacts to an external stimulus. Substances that show a color change due to the effect of heat (thermochromism), chemical oxidation or reduction, in the presence of certain metal ions (complexation) or pH change were investigated. Similarly, commercial color pigments have been embedded in a hydrophobic matrix (e.g., wax or oil), and coloration achieved by mechanical shear and thus distribution in the target medium. Chemical mechanisms for producing a color transition (i.e., chemically induced color changes) that, in a first reaction, at least produce a color transition by pH change, complexation, and/or release of embedded color pigments have been identified as mechanisms well suited for the application.

The combination, in particular time-delayed (also referred to as sequential) combination, of different color transitions based on different chemical reactions has also been investigated, e.g. the decolorization of a first dye as a result of a pH change (as an example of a first—chemically induced—color change) and the time-delayed recolorization by release of a color pigment as a second dye (as an example of a second—mechanically induced—color change). Suitable dyes are, for example, pH indicators, and suitable pH indicators are listed here as examples. For the—chemically induced—color change by pH value change, the following combinations of pH indicators, among others, are very well suited for a red-green color change, since they perform the change in the pH skin-neutral range (pH=4.5-7): a mixture of thymol blue, methyl red, bromothymol blue and phenolphthalein (known as “Tamada indicator”);
Methyl red and bromocresol blue;
Methyl red and bromocresol green.

Suitable redox indicators are exemplified herein and include, for example, methylene blue, neutral red, ferroin, dichlorophenol indophenol (DCPIP), resazurin, and mixtures thereof.

Typical concentrations for the indicator, such as the pH indicator, redox indicator, complex indicator, are, for example, in the range between 0.01-1% by weight based on the mass of all components of the soap. The concentration of the indicator can be selected or specifically adjusted by the skilled person depending on the desired color intensity.

In addition to a variety of possible bases, the following are suitable as bases that cause a change in pH: (earth) alkali metal carbonates, such as sodium carbonate, sodium hydrogen carbonate, calcium carbonate, magnesium carbonate; (earth) alkali metal phosphates, such as. Sodium phosphate, sodium hydrogen phosphate, sodium dihydrogen phosphate: mesoporous silica materials, such as, mullite, kaolinite, montmorillonite, bentonite, halloysite; zeolites, in particular zeolite HY (Si:Al=80:1), zeolite β (Si:Al=360:1), zeolite. (3 Ä), zeolite (4 Ä), zeolite (5 Ä), zeolite 13 X, zeolite NaY (Si:Al=5.1:1), zeolite HY (Si:Al=5.1:1) or mixtures thereof. The aforementioned bases are characterized in particular by their good skin compatibility.

Typical base concentrations, for example, are in the range between 0.01-10% by weight based on the sum of the masses of all components of the soap. Commercial liquid soaps are often formulated with a citrate buffer system, so that the amount of base to be used depends on the strength of the respective base, its solubility in water, as well as on the composition of the soap formulation. However, the person skilled in the art can take this into account accordingly by means of corresponding table values and/or calculations.

The color change due to the release of non-soluble, embedded color pigments is basically not restricted to a specific type. For the delayed release that causes coloration, the pigments are embedded in preferably hydrophobic compounds such as oils or waxes. Suitable media for embedding include stearins, kerosenes, beeswax, rhea butter or carnauba wax. The release is achieved by mechanical rubbing of the mixture in the target medium. The pigments can already be highly effective in concentrations of 0.01-0.1% by weight based on the sum of the masses of all components of the soap.

For example, the waxes are present in concentrations between 0.1-10% by weight based on the sum of the masses of all components of the soap within the soap.

Metal ions such as calcium or magnesium are suitable for the—chemically induced—color transition by complexation, since they are also contained in water and have no toxic effect on the human organism. Examples of organic compounds that undergo a—chemically induced—color change by complexation of calcium or magnesium are calconic carboxylic acid or alizarin red S. If these come into contact with compounds that have a greater tendency to complexation, such as ethylenediaminetetraacetate (EDTA) or sodium gluconate, the complexes formed from the metal ion and the coloring complexing agent can be dissolved, whereupon a—chemically induced—color transition occurs. Typical concentrations of the coloring complexing agents and the decolorizing complexing agents are between 0.01-1.00% by weight based on the sum of the masses of all components of the soap. The concentration of the coloring complexing agent and of the decolorizing complexing agent can be selected or specifically adjusted by the skilled person depending on the desired color intensity. For this purpose, the skilled person refers to suitable literature from which the complexation constants can be obtained.

In order to achieve the color change effect not immediately, but only during use (washing, e.g. hands), the agents can be protected from the soap, and in some cases they can also be physically separated from each other. For this purpose, the agents can, for example, be encapsulated separately from one another or together. Dense, non-porous coatings of cores containing the agents with crosslinked polymers or mineral materials are particularly suitable as soap stable capsule shells.

### LIST OF FIGURES AND DRAWINGS

The present invention is explained in more detail below with reference to the embodiments indicated in the schematic figures of the drawings.

FIG. 1 shows a schematic representation of a cleaning or soap product according to one embodiment of the present invention;

FIG. 2 is a schematic representation of a cleaning or soap product according to one embodiment of the present invention;

FIG. 3 a schematic representation of a cleaning or soap product according to one embodiment of the present invention;

FIG. 4 a schematic representation of a cleaning or soap product according to one embodiment of the present invention;

FIG. 5 a schematic representation of a cleaning or soap product according to one embodiment of the present invention; FIG. 6 a schematic representation of a cleaning or soap product according to one embodiment of the present invention.

FIG. 7 a schematic representation of a cleaning or soap product with two substances within a capsule-like structure, wherein the two substances are present separately in a first core and a second core.

In all figures, identical or functionally identical elements and devices have been given the same reference signs unless otherwise indicated.

### FIGURE DESCRIPTIONS

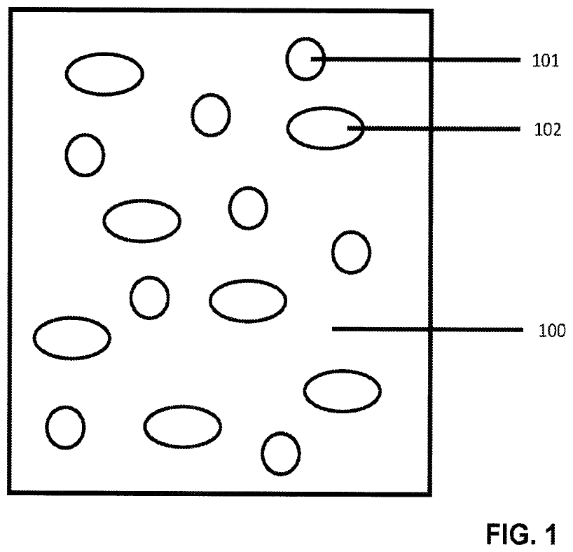

FIG. 1 is a schematic representation of a cleaning or soap product according to one embodiment of the present invention. A soap, such as a substantially liquid hand washing soap, is symbolically represented by the soap continuum 100. The continuum may be continuous and thereby, for example, liquid, but it may also contain, for example, small particles, beads, bubbles or the like.

The capsule-like structure 101 is, for example, an alginate capsule 101, but numerous alternative materials exist. The capsule 101 may be transparent in design, but need not be. The capsule 101 is shown circular, but other shapes may be used.

In one example, the capsule is filled with a substance comprising a dye or pigment. For example, this is a thermochromic pigment. For example, the pigment is red below a threshold temperature. For example, the pigment is colorless above a threshold temperature.

For example, a user removes a quantity of soap and begins a use, cleaning, or hand washing process. During this process, the capsules 101 break open and the soap turns red due to the released pigment. Consecutive continuation of use, for example, adds hand heat to the soap due to thermal contact of the hands with the soap. This may, for example, cause the threshold to be exceeded (for example, 24, 26, 28, 30, or 32 degrees), causing the soap to take on the color “colorless.”

The capsule-like structure 102 is, for example, an alginate capsule 102, but numerous alternative materials exist, The capsule 102 may be transparent in design, but need not be. The capsule 102 is shown as oval, but other shapes may be used.

In one example, the capsule is filled with a substance comprising a dye or pigment. For example, this is a thermochromic pigment. For example, the pigment is a green interval pigment. For example, the pigment is colorless outside a certain temperature interval, while it is colored inside the temperature range. Colored here means green, for example.

The capsule-like structures 102 may be different from the capsule-like structures 101.

Merely, for example, the capsules 102 are different in thickness, size, and material. For example, as a result, the capsules 102 are more robust, whereby release of the contents by destruction of the capsules 102 is delayed, i.e., occurs later in time (sequentially), compared to release of the contents by destruction of the capsules 101. For example, the properties of the capsules 102 are adjusted so that a color change due to release of the contents of the capsules 102 is clearly produced during a usual hand washing process when the user has washed his hands for a certain time and with sufficient thoroughness. This may be the case, for example, after 15, 20, 30 or 40 seconds of thorough and intensive hand washing. Therrnochromic substances do not necessarily have to be used. Permanently colored pigments are also possible. Various mechanisms for producing a color change which are disclosed within the scope of this document and/or which are known to the skilled person can also be used in connection with a system of capsule-like structures or other carrier structures. For example, another carrier structure is provided by small particles or beads, in particular beads comprising waxes, fats or oils, into which is introduced by mixing a colored substance or a substance otherwise causing a color change when mixed with the soap continuum. For example, such beads melt during hand washing or are mechanically sheared or crushed, whereby a colored substance or a substance otherwise causing a color change when mixed with the soap continuum is released into the soap continuum and mixed.

Another suitable active ingredient system for producing the color change is given, for example, by methylene blue and glucose. Methylene blue exhibits a dyed state of blue color. Methylene blue can be deodorized by glucose, for example. It can be colored by oxygen. In particular, methylene blue can thus be successively, i.e., in particular reversibly, dyed blue and decolorized again. For example, methylene blue is present in blue, i.e. colored, form. Methylene blue can be reduced to the colorless leuco form, called leuco-methylene blue. For example, this is done by glucose, which is oxidized to gluconic acid in the process. In this process, leuco-methylene blue can be oxidized to the methylene blue with blue color by a suitable oxidizing agent. A suitable oxidizing agent can be oxygen, in particular atmospheric oxygen. This has the effect that a color transition in a soap, which occurs when the soap is used, can be effectively and inexpensively realized by the high surface contact of the soap with atmospheric oxygen during the soaping process. In particular, no separate substance, mechanism or oxidizing agent is required for this purpose.

However, if necessary, a deliberately used oxidizing agent, such as oxygen, can also be deliberately used. For example, a structure is used in which oxygen can be introduced or enriched. For example, such a structure may then be incorporated into a capsule-like structure or other support structure within the meaning of the invention.

Another suitable active substance system for producing the color change is given, for example, by Tillman's reagent and vitamin C or ascorbic acid. Here, for example, 2,6-dichlorophenol-indophenol can be used in the context of another compound or another salt. not only as a sodium salt. For example, a red color is present in an acidic environment. Here, for example, the ascorbic acid provides a decolorization of the system when the capsules are mixed or broken open.

Another suitable active ingredient system for producing the color change is given, for example, by Eriochrome Black T (Eriochromschwarz-T). For example, hardness formers (in the sense of water hardness), in particular calcium and/or magnesium ions, are involved in the system, especially in a capsule-like structure or other carrier structure. This can very effectively produce a red-green color transition, or alternatively a color change which is very similar to a red-green color change.

Another suitable active ingredient system for generating the color change is also provided, for example, by pH indicators. For example, a pH indicator is present in the soap continuum 100 or in a capsule-like structure 101. In one example, the active ingredient system further comprises at least one pig-changing substance. For example, these substances may comprise citric acid or soda ash. For example, these substances are incorporated in a capsule-like structure 102 or alternative carrier structure.

For example, during a hand washing process, first the contents of the capsule-like structure 101 are released and then, with a time delay, in particular assuming a sufficient washing intensity, the contents of the capsule-like structure 102. For example, at least two color changes occur. For example, one color change occurs at the beginning of a hand washing process and another after sufficient duration and/or intensity has occurred.

Other suitable pigments, pigment systems and chemically active systems can be found in the patent claims. The pigments, pigment systems and active chemical ingredient systems disclosed herein may be incorporated within the framework of a capsule-like structure, another/alternative carrier structure (such as wax or fat globules) or within the soap continuum. Often, especially in the case of two-part active ingredient systems to produce a color transition, both parts may be incorporated in capsules. These can, for example, be different capsules 101 and 102. However, there may also be, for example, a part of the active ingredient system in the soap continuum 100. For example, said part of the active ingredient system is then released as part of a first chemical and/or mechanical mechanism by mechanical breaking/shearing of the capsules. This part then reacts with the other part already present in the soap continuum, during further mixing, to chemically produce a color change (in this case, therefore, a second chemical and/or mechanical mechanism).

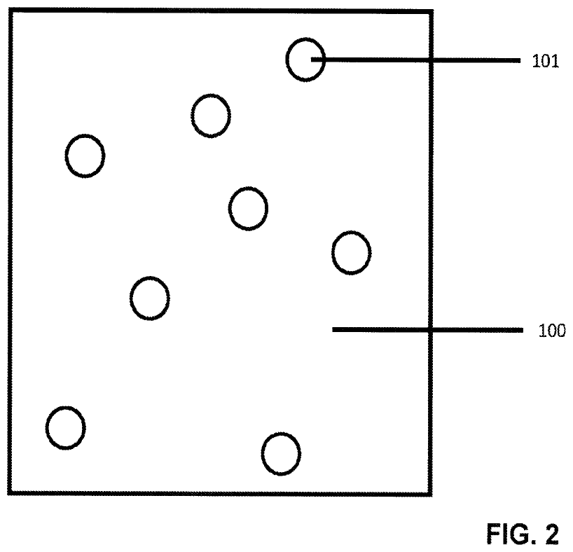

FIG. 2 is a schematic representation of a cleaning or soap product according to one embodiment of the present invention, A soap, such as a substantially liquid hand washing soap, is symbolically represented by the soap continuum 100. The continuum may be continuous and thereby, for example, liquid, but it may also contain, for example, small particles, beads, bubbles or the like.

The capsule-like structure 101 is, for example, an alginate capsule 101, but numerous alternative materials exist. The capsule 101 may be transparent in design, but need not be. The capsule 101 is shown circular, but other shapes may be used.

In one example, the capsule is filled with a substance comprising a dye or pigment. For example, this is a thermochromic pigment. For example, the pigment is red below a threshold temperature. For example, the pigment is colorless above a threshold temperature.

For example, a user removes a quantity of soap and begins a use, cleaning, or hand washing process. During this process, the capsules 101 break open and the soap turns red due to the released pigment. Consecutive continuation of use, for example, adds hand heat to the soap due to thermal contact of the hands with the soap, This may, for example, cause the threshold to be exceeded (for example, 24, 26, 28, 30, or 32 degrees), causing the soap to take on the color “colorless.”

The active ingredient systems discussed in connection with FIG. 1 can also be used, for example, in the context of a soap as shown in FIG. 2.

As shown, the soap of FIG. 2 has only one type of capsule-like structures 101, for example, a part of the active ingredient system that can cause color changes is arranged in the soap continuum 100.

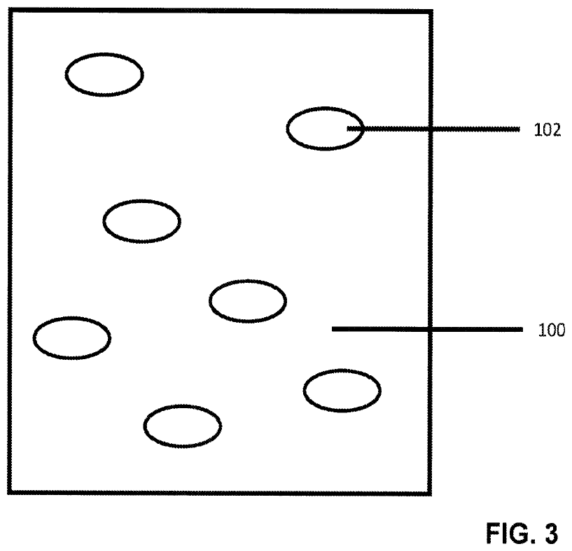

FIG. 3 is a schematic representation of a cleaning or soap product according to one embodiment of the present invention. A soap, such as a substantially liquid hand washing soap, is symbolically represented by the soap continuum 100. The continuum may be continuous and thereby, for example, liquid, but it may also contain, for example, small particles, beads, bubbles or the like.

The capsule-like structure 102 is, for example, an alginate capsule 102, but numerous alternative materials exist. The capsule 102 may be transparent in design, but need not be. The capsule 102 is shown as oval, but other shapes may be used.

In one example, the capsule is filled with a substance comprising a dye or pigment. For example, this is a thermochromic pigment. For example, the pigment is red below a threshold temperature. For example, the pigment is colorless above a threshold temperature.

For example, a user removes a quantity of soap and begins a use, cleaning, or hand washing process, During this process, the capsules 101 break open and the soap turns red due to the released pigment. Consecutive continuation of use, for example, adds hand heat to the soap due to thermal contact of the hands with the soap. This may, for example, cause the threshold to be exceeded (for example, 24, 26, 28, 30, or 32 degrees), causing the soap to take on the color “colorless.”

The active ingredient systems discussed in connection with FIG. 1 can also be used, for example, in the context of a soap as shown in FIG. 3.

As shown, the soap of FIG. 3 has only one type of capsule-like structures 101.

For example, part of the active ingredient system that can cause color changes is also arranged in the soap continuum 100.

A color transition in the sense of the invention can be a change from one color to another color, e.g. from red color to green color or vice versa. However, a color transition can also be a transition from colorless to a color or from a color to colorless. Black, white and transparent in particular are also to be considered as colors in the sense of the invention.

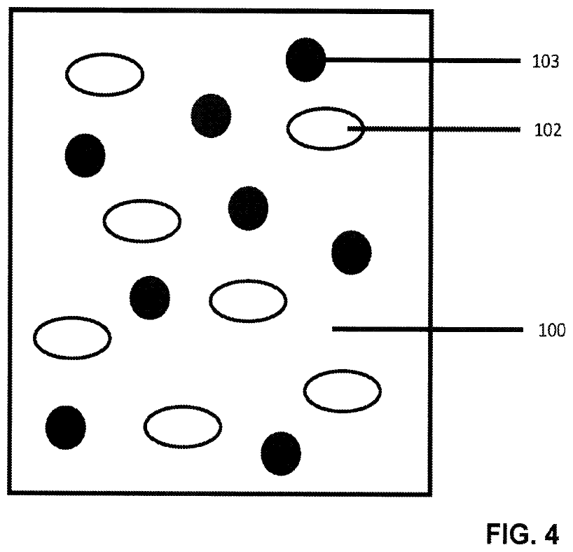

FIG. 4 is a schematic representation of a cleaning or soap product according to one embodiment of the present invention. A soap, such as a substantially liquid hand washing soap, is symbolically represented by the soap continuum 100. The continuum may be continuous and thereby, for example, liquid, but it may also contain, for example, small particles, beads, bubbles or the like.

The capsule-like structure 102 is, for example, an alginate capsule 102, but numerous alternative materials exist. The capsule 102 may be transparent in design, but need not be. The capsule 102 is shown as oval, but other shapes may be used.

In one example, the capsule is filled with a substance comprising a dye or pigment. For example, this is a thermochromic pigment. For example, the pigment is red below a threshold temperature. For example, the pigment is colorless above a threshold temperature.

For example, a user removes a quantity of soap and begins a use, cleaning, or hand washing process. In the process, the capsules 102 break open and the soap turns red due to the released pigment.

The alternative carrier structure 103 is, for example, small beads of waxes, fats or oils. For example, these waxes, fats or oils are mixed with a dye or part of an active ingredient system enabling a color change. Thus, another carrier structure is provided, for example, by small particles or beads, in particular beads comprising waxes, fats or oils, into which is introduced by mixing a colored substance or a substance otherwise causing a color change when mixed with the soap continuum. For example, such beads melt during hand washing or are mechanically sheared or crushed, whereby a colored substance or a substance otherwise causing a color change when mixed with the soap continuum is released into the soap continuum and mixed.

In one example, a pigment is included in the beads 103. For example, this is phthalogreen or another green pigment. This creates, for example, an “alternative thermochromic effect” when the soap is used, as the beads 103 are mechanically pulverized or melted by heat, thereby releasing the dye or active ingredient. In one example, this releases phthalogreen and gives the soap a green coloration.

All dyes and active ingredient systems can be combined with the structure of the soap of FIG. 4. The capsule-like structures 102 and the carrier structures 103 already provide at least two mechanisms with which at least two color changes can be achieved.

The capsule-like structures 102 and the support structures 103 may be arranged such that, when the soap is used, the capsule-like structures 102 break first (for example, approximately at the beginning of a use), and, temporally later, the support structures 103 break or melt (for example, when the soap has been used sufficiently). However, this temporal sequence is merely exemplary. The time sequence can also be reversed, such that the carrier structures 103 are destroyed first and the capsule-like structures 102 are destroyed later.

The capsule-like structures 102 may differ greatly in nature from the support structures 103. The also includes properties such as size and robustness.

Thermochromic substances do not necessary have to be used. Permanently colored pigments are also possible. Various mechanisms for producing a color change which are disclosed within the scope of this document and/or which are known to the person skilled in the art can also be used in connection with a system of capsule-like structures and carrier structures.

Another suitable active ingredient system for producing the color change is given, for example, by methylene blue and glucose. Methylene blue exhibits a dyed state of blue color. Methylene blue can be decolorized by glucose, for example. It can be colored by oxygen. In particular, methylene blue can thus be successively, i.e., in particular reversibly, dyed blue and decolorized again. For example, methylene blue is present in blue, i.e. colored, form. Methylene blue can be reduced to the colorless leuco form, called leuco-methylene blue. For example, this is done by glucose, which is oxidized to gluconic acid in the process. In this process, leuco-methylene blue can be oxidized to the methylene blue with blue color by a suitable oxidizing agent. A suitable oxidizing agent can be oxygen, in particular atmospheric oxygen. This has the effect that a color transition in a soap, which occurs when the soap is used, can be effectively and inexpensively realized by the high surface contact of the soap with atmospheric oxygen during the soaping process. In particular, no separate substance, mechanism or oxidizing agent is required for this purpose.

However, if necessary, a deliberately used oxidizing agent, such as oxygen, can also be deliberately used. For example, a structure is used in which oxygen can be introduced or enriched. For example, such a structure may then be incorporated into a capsule-like structure or other support structure within the meaning of the invention.

Another suitable active substance system for producing the color change is given, for example, by Tillman's reagent and vitamin C or ascorbic acid. Here, for example, 2,6-dichlorophenol-indophenol can be used in the context of another compound or another salt, not only as a sodium salt. For example, a red color is present in an acidic environment.

Here, for example, the ascorbic acid provides a decolorization of the system when the capsules are mixed or broken open.

Another suitable active ingredient system for producing the color change is given, for example, by Eriochrome Black T (Eriochromschwarz-T). For example, hardness formers (in the sense of water hardness), in particular calcium and/or magnesium ions, are involved in the system, especially in a capsule-like structure or other carrier structure. This can very effectively produce a red-green color transition, or alternatively a color change which is very similar to a red-green color change.

Another suitable active ingredient system for generating the color change is also provided, for example, by pH indicators. For example, a pH indicator is present in the soap continuum 100 or in a capsule-like structure 101. In one example, the active ingredient system further comprises at least one pH-changing substance. For example, these substances may comprise citric acid or soda ash. For example, these substances are incorporated in a capsule-like structure 102 or alternative carrier structure.

For example, during a hand washing process, first the contents of the capsule-like structure 101 are released and then, with a time delay, in particular assuming a sufficient washing intensity, the contents of the capsule-like structure 102. For example, at least two color changes occur. For example, one color change occurs at the beginning of a hand washing process and another after sufficient duration and/or intensity has occurred.

Other suitable pigments, pigment systems and chemically active systems can be found in the patent claims. The pigments, pigment systems and active chemical ingredient systems disclosed herein may be incorporated within the framework of a capsule-like structure, another/alternative carrier structure (such as wax or fat globules) or within the soap continuum. Often, especially in the case of two-part active ingredient systems to produce a color transition, both parts may be incorporated in capsules. These can, for example, be different capsules 101 and 102. However, there may also be, for example, a part of the active ingredient system in the soap continuum 100. For example, said part of the active ingredient system is then released as part of a first chemical and/or mechanical mechanism by mechanical breaking/shearing of the capsules. This part then reacts with the other part already present in the soap continuum, during further mixing, to chemically produce a color change (in this case, therefore, a second chemical and/or mechanical mechanism).

A color transition in the sense of the invention can be a change from one color to another color, e.g. from red color to green color or vice versa. However, a color transition can also be a transition from colorless to a color or from a color to colorless. Black, white and transparent in particular are also to be considered as colors in the sense of the invention.

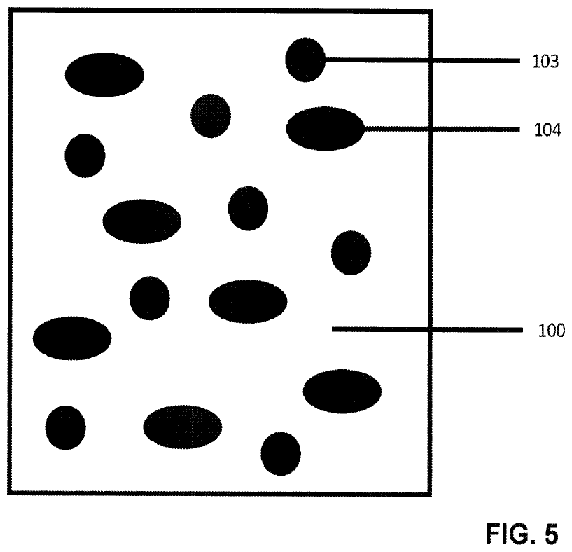

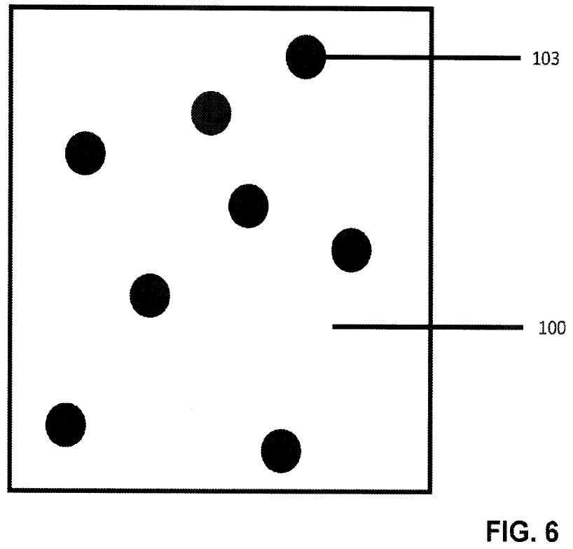

FIG. 5 is a schematic representation of a cleaning or soap product according to one embodiment of the present invention. A soap, such as a substantially liquid hand washing soap, is symbolically represented by the soap continuum 100. The continuum may be continuous and thereby, for example, liquid, but it may also contain, for example, small particles, beads, bubbles or the like.

The soap of FIG. 5 employs at least two different alternative support structures 103, 104. The alternative carrier structures 103, 104 are, for example, small beads of waxes, fats or oils. For example, these waxes, fats or oils are mixed with a dye or part of an active ingredient system enabling a color change. Thus, another carrier structure is provided, for example, by small particles or beads, in particular beads comprising waxes, fats or oils, into which is introduced by mixing a colored substance or a substance otherwise causing a color change when mixed with the soap continuum. For example, such beads melt during hand washing or are mechanically sheared or crushed, whereby a colored substance or a substance otherwise causing a color change when mixed with the soap continuum is released into the soap continuum and mixed.

In one example, a pigment is included in the beads 103 and/or the beads 104. For example, this is phthalogreen or another green pigment. This creates, for example, an “alternative thermochromic effect” when the soap is used, as the beads 103 or 104 are mechanically pulverized or melted by heat, thereby releasing the dye or active ingredient. In one example, this releases phthalogreen and gives the soap a green coloration.

In one example, a green dye or an active ingredient that causes a green color change is released from the beads 103. In one example, a red dye or an active substance which causes a red color change is released from the beads 104. In particular, this can also be a substance which has red color but is successively decolorized by a mechanism.

For example, an effective red-green transition can be produced with successive use of the soap. For example, the beads 104 are destroyed first, at the start of a wash, and the beads 103 are destroyed after sufficient use of the soap.

All dyes and active ingredient systems can be combined with the structure of the soap of FIG. 5. The carrier structures 103 of the first type and the carrier structures 104 of the second type already provide at least two mechanisms with which at least two color changes can be achieved.

The support structures 103 of the first type and the support structures 104 of the second type may be arranged such that, when the soap is used, the support structures 104 of the second type break first (for example, approximately at the beginning of a use), and, temporally later, the support structures 103 of the first type break or melt (for example, when the soap has been used sufficiently). However, this temporal sequence is merely exemplary. The chronological sequence can also be reversed, so that the carrier structures 103 of the first type are destroyed first and the carrier structures 104 of the second type are destroyed only later.

The carrier structures 103 of the first type can differ greatly from the carrier structures 104 of the second type in their nature. The also includes properties such as size, carrier material, density, melting temperature and robustness.

Thermochromic substances do not necessarily have to be used, although this is of course also possible. Permanently colored pigments are also possible. Various mechanisms for producing a color change which are disclosed within the scope of this document and/or which are known to the skilled person can also be used in connection with a system of capsule-like structures and carrier structures.

The active ingredient systems discussed in connection with the other figures can also be used, for example, in the context of a soap as shown in FIG. 5.

As shown, the soap of FIG. 5 has at least two types of support structures 103, 104.

For example, part of an active ingredient system that can cause color changes is also arranged in the soap continuum 100.

A color transition in the sense of the invention can be a change from one color to another color, e.g. from red color to green color or vice versa. However, a color transition can also be a transition from colorless to a color or from a color to colorless. Black, white and transparent in particular are also to be considered as colors in the sense of the invention.

FIG. 6 is a schematic representation of a cleaning or soap product according to one embodiment of the present invention. A soap, such as a substantially liquid hand washing soap, is symbolically represented by the soap continuum 100. The continuum may be continuous and thereby, for example, liquid, but it may also contain, for example, small particles, beads, bubbles or the like. The active ingredient systems discussed in connection with the other figures can also be used, for example, in the context of a soap as shown in FIG. 6.

As shown, the soap of FIG. 6 gets by with only one support structure 103.

For example, there may be a pigment in the carrier structure. For example, there may also be a part of an active ingredient system in the carrier structure 103. For example, part of an active ingredient system that can cause color changes is also arranged in the soap continuum 100.

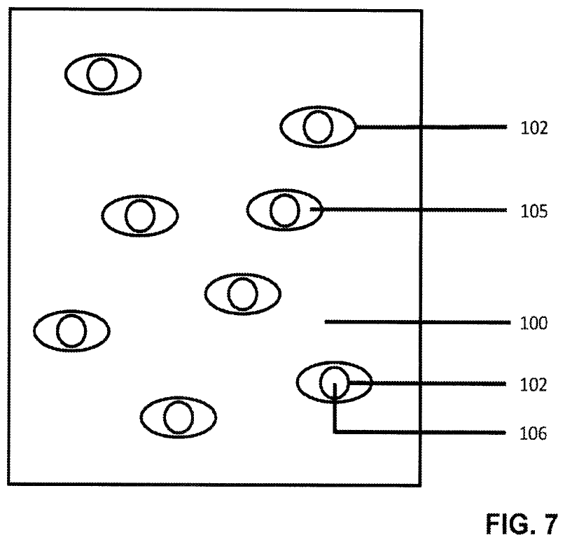

FIG. 7 is a schematic representation of a cleaning or soap product according to one embodiment of the present invention. A soap, such as a substantially liquid hand washing soap, is symbolically represented by the soap continuum 100. The continuum may be continuous and thereby, for example, liquid, but it may also contain, for example, small particles, beads, bubbles or the like.

The soap of FIG. 7 has two carrier structures comprising two substances, the two substances being present within two capsule-like structures, the first capsule-like structure 102 forming a first core 105 within which the first substance and the second type capsule-like structure 102 are disposed. The second type capsule-like structure 102 forms a second core 106 within which the second substance is disposed. As a result, the two substances are present separately in a first core 105 and a second core 106.

The first substance is an indicator, in particular a pH indicator or a complex indicator. Indicators do not necessarily have to be used, although this is of course also possible. Permanent colored pigments are also possible.

In this regard, the first color transition is preferably a mechanical mechanism for producing a first color transition of the cleaning or soap product (i.e., mechanically induced color transition). Here, the first color transition is initiated and/or caused by a rupturing, mechanical shearing or disruption of the capsule-like structure 102, whereby the dye (e.g., the indicator) or the permanently colored pigments as well as the capsule-like structure of the second type 102 enclosed and/or embedded in the first core 105 are released into the soap continuum. The release of this first colored substance and the mixing thereof with the soap continuum causes the first color transition.

In FIG. 7, the second substance is released into the soap continuum only when the capsule-like structure of the second type 102 is broken open, mechanically sheared or destroyed. In this case, the second substance enclosed in the second core 106 may be another incorporated dye (for example, the indicator), a permanent colored pigment, a pH-indicating substance, and/or a complexing agent.

By releasing and distributing the second substance into the soap continuum causes the second color transition.

If the second substance is a pH-indicating substance and/or a complexing agent, the second color transition preferably occurs by way of a chemical mechanism as a result of which the first released substance changes color. By distributing the second substance or propagating the chemical reaction within the soap continuum, a color transition is indicated within the soap continuum.

If the second substance is an incorporated dye (e.g. the indicator) and/or a permanent colored pigment, the second color transition preferably occurs by way of a mechanical mechanism, wherein after the rupture of the capsule-like structure of the second type 102, the second released substance distributes itself in the soap continuum.

A color transition in the sense of the invention can be a change from one color to another color, e.g. from red color to green color or vice versa. However, a color transition can also be a transition from colorless to a color or from a color to colorless. Black, white and transparent in particular are also to be considered as colors in the sense of the invention.

### Non-Limiting Examples

### Example 1—Handwash Soap Comprising a First Mechanically Induced Color Transition and a Time Delayed Second Chemically Induced Color Transition

In a colorless soap solution, which has a pH of 4.8, two different types of capsules (so-called capsule-like structure) are presented, which have a particle size with an average particle diameter between 100-500 pm. A first type of capsules contains the indicator mixture comprising equal proportions of the dyes methyl red and bromocresol green (pKₐ value is about 4.90 and exhibits a color change from yellow to green to deep blue in a βH/pH range of 3.8-5.4), which constitute a total proportion of 0.05% by weight based on the mass of the total mixture within the volume of the first type of capsules. The second type of capsules (so-called capsule-like structure of the second type) contains a paraffin-based core in which sodium hydrogen carbonate is contained, the sodium hydrogen carbonate accounting for a total proportion of 0.5% by weight in relation to the mass of the total mixture within the volume of the second type of capsule.

The soap is applied to the hand, and rubbed on and inside the palms with the addition of water. Due to the defined bursting of the first type of capsules and distribution of the active ingredients in the soap solution, the soap solution on the hand initially turns red. With the bursting of the second type of capsules and respectively through increasing distribution of the sodium hydrogen carbonate, the pH value of the soap changes continuously to a value between 6.0-7.0, resulting in a color change to green.

### Example 2—Handwashing Soap Comprising a First Mechanically Induced Color Transition and a Time-Delayed Second Chemically Induced Color Transition

In a colorless soap solution, which has a pH of 4.8, two different types of capsules (so-called capsule-like structure) are presented, which have a particle size with an average particle diameter between 100-500 pm. A first type of capsules contains the dye methyl red in a total amount of 0.03% by weight based on the mass of the total mixture within the volume of the first type of capsule. The second type of capsules contains a paraffin-based core in which sodium carbonate in a total proportion of 0.1% by weight and the color pigment Puricolor PGR7 (manufacturer BASF) in a total proportion of 0.02% by weight, each based on the mass of the total mixture within the volume of the second type of capsules.

The soap is applied to the hand and rubbed on and inside the palms with the addition of water. Due to defined bursting of the capsules and distribution of the active ingredients in the soap solution, the soap initially turns red. With increasing distribution of the sodium hydrogen carbonate and the Puricolor PGR7 color pigment, the pH of the soap changes continuously to a value between 6.0-7.0, resulting in a color change to green.

### LIST OF REFERENCE SIGNS

100 Soap/Soap continuum

101 Capsule type structure

102 Second type capsule type structure

103 Alternative carrier structure/wax beads

104 Alternative carrier structure/wax beads of the second type

105 First core

106 Second core

1-31. (canceled)

32. A cleaning or soap product, in particular personal care product, in particular hand washing soap, comprising: a first chemical and/or mechanical mechanism for generating a first color transition of the cleaning or soap product, a second chemical and/or mechanical mechanism for generating a second color transition.

33. The cleaning or soap product according to claim 32, wherein a capsule-like structure, in particular gel capsule, is used in the first chemical and/or mechanical mechanism, wherein the first color transition is initiated and/or effected by a breaking, a mechanical shearing or a destruction of the capsule-like structure.

34. The cleaning or soap product according to claim 32, wherein a capsule-like structure, in particular gel capsule, is used in the second chemical and/or mechanical mechanism, wherein the second color transition is initiated and/or effected by a breaking, a mechanical shearing or a destruction of the capsule-like structure.

35. The cleaning or soap product according to claim 33, wherein a capsule-like structure, in particular gel capsule, is used in the second chemical and/or mechanical mechanism, wherein the second color transition is initiated and/or effected by a breaking, a mechanical shearing or a destruction of the capsule-like structure and wherein the second chemical and/or mechanical mechanism employs a capsule-like structure that differs from the capsule-like structure employed in the first chemical and/or mechanical mechanism, in particular if it differs in at least one aspect from: Size, thickness, material, surface finish.

36. The cleaning or soap product according to claim 32, wherein the first and/or the second chemical and/or mechanical mechanism is based on a chemical reaction wherein the chemical reaction comprises an involvement of at least a first and a second component, wherein the first component is arranged in a first capsule-like structure, in particular gel capsule.

37. The cleaning or soap product of claim 36, wherein the second component is disposed in the soap continuum.

38. The cleaning or soap product according to claim 36, wherein the second component is arranged in a second capsule-like structure, in particular gel capsule.

39. The cleaning or soap product according to claim 32, wherein the second chemical and/or mechanical mechanism is based on a chemical reaction caused by contact with oxygen, in particular atmospheric oxygen and/or wherein the first and/or second chemical and/or mechanical mechanism relies on a reaction involving a hydrolipid film.

40. The cleaning or soap product according to claim 32, wherein a thermochromic substance is used in the first and/or second chemical and/or mechanical mechanism.

41. The cleaning or soap product according to claim 32, wherein in the first and/or second chemical and/or mechanical mechanism a pH-value-indicating substance is used, in particular a pH-value-indicating substance which is suitable for indicating an envelope in the range from pH 4.5 to pH 9, in particular at least one of: Methyl red, alizarin red, chlorophenol red, p-nitrophenol, hematoxylin, litmus, azolitmin, bromothymol blue, phenol red, neutral red, cresol red, naphtholphthalein, in particular mixtures of at least two pH-indicating substances.

42. The cleaning or soap product according to claim 32, wherein a carrier structure, in particular in the form of beads and/or powder form, in particular beads and/or powder comprising waxes, fats or oils, is used in the first and/or second chemical and/or mechanical mechanism, wherein the second color transition is initiated and/or effected by a melting of the carrier structure.

43. The cleaning or soap product according to claim 32, wherein a pH-value-changing substance is used in the first and/or second chemical and/or mechanical mechanism, in particular a pH-value-changing substance which is introduced into a capsule-like structure or other carrier structure, in particular beads and/or powder comprising waxes, fats or oils, in particular an acid and/or base, in particular citric acid and/or soda.

44. The cleaning or soap product according to claim 32, wherein in the first and/or second chemical and/or mechanical mechanism a complex-forming and/or water hardness-degree-changing substance is used, which is introduced into a capsule-like structure or other carrier structure, in particular beads and/or powder comprising waxes, fats or oils, in particular complexing agents, in particular hardness formers in the sense of water hardness, in particular ions of alkaline earth metals, in particular calcium, magnesium, strontium and/or barium ions, and/or iron and/or aluminum ions.

45. The cleaning or soap product according to claim 32, wherein the first chemical and/or mechanical mechanism produces a color transition that is substantially effected and visible at a time of a withdrawal and/or a start of use of the cleaning or soap product.

46. The cleaning or soap product according to claim 32, wherein a red thermochromic dye is used, in particular in a capsule-like structure or another carrier structure, and a green interval pigment, in particular in a capsule-like structure or another carrier structure.

47. The cleaning or soap product according to claim 32, wherein a substance comprising methylene blue and/or indigo carmine is brought into use, in particular in a capsule-like structure or another carrier structure, and a substance comprising glucose, in particular in a capsule-like structure or another carrier structure and/or wherein a substance comprising a hardness indicator, in particular eriochrome black T, and/or complexing agents, in particular murexide, ethylenediaminetetraacetate and/or ethylenediaminetetraacetic acid (EDTA), dimethylglyoxime, alizarin, diphenylcarbazide, yellow and/or red blood leach salt, is used, in particular in a capsule-like structure or another carrier structure, and a substance comprising complexing agents and/or hardness formers, in particular calcium and/or magnesium ions, in particular in a capsule-like structure or another carrier structure.

48. The cleaning or soap product according to claim 32, wherein the second chemical and/or mechanical mechanism operates on the basis of a limited and/or delayed onset solubility, in particular water solubility, of a substance, in particular a free substance and/or substance provided in a capsule-like structure or other carrier structure.

49. A process for preparing a cleaning or soap product, in particular personal care product, in particular hand washing soap, that comprises a first chemical and/or mechanical mechanism for generating a first color transition of the cleaning or soap product, and a second chemical and/or mechanical mechanism for generating a second color transition, the process comprising: providing a first chemical and/or mechanical mechanism suitable for producing a first color transition of the cleaning or soap product, and providing a second chemical and/or mechanical mechanism suitable for producing a second color transition.

50. The cleaning or soap product according to claim 32, wherein a substance comprising a green color pigment is used, in particular a PGR7 color pigment, for example Puricolor PGR7, in particular in a capsule-like structure or another carrier structure.

51. The cleaning or soap product according to claim 50, wherein phenol red is used, in particular in the soap continuum and/or set free via the first chemical and/or mechanical mechanism.
